(19) United States
(12) Patent Application Publication
(10) Pub. No.: US 2022/0090658 A1
(43) Pub. Date: Mar. 24, 2022

(54) LINEAR ACTUATOR WITH ADJUSTABLE STROKE LENGTH

(71) Applicant: FIRGELLI AUTOMATIONS INC., Surrey (CA)

(72) Inventor: Robbie Dickson, Surrey (CA)

(73) Assignee: FIRGELLI AUTOMATIONS INC., Surrey (CA)

(21) Appl. No.: 17/376,532

(22) Filed: Jul. 15, 2021

Related U.S. Application Data
(60) Provisional application No. 63/082,990, filed on Sep. 24, 2020.

(51) Int. Cl. F16H 25/20; H02K 7/06; H02K 7/116

(52) U.S. Cl. CPC F16H 25/2015; F16H 2025/2081; H02K 7/116; H02K 7/06

(57) ABSTRACT

A linear actuator with an adjustable stroke length. The linear actuator includes a main rod that moves along a linear stroke length. At least one end of the stroke length is defined by a limit switch. The linear actuator includes an adjustment mechanism which is configured to allow a user to change the stroke length of the device by moving the limit switch without having to open the linear actuator.

### FIELD

The present disclosure relates to a linear actuator with a user-adjustable stroke length which can be altered with minimal effort and without opening the linear actuator.

### BACKGROUND

An electric linear actuator is a device which converts rotary motion of an electric motor into linear motion of a rod. A linear actuator can be used to extend and retract a rod within a stroke length of the device. This can be used to lift, drop, slide, adjust, tilt, push or pull objects simply by pushing a button. Among other uses, linear actuators can be used for motorized hatches, kitchen appliance lifts, marine engine hatches, slide out steps, snow plow adjusters, hoppers, hidden doors, solar panels, sliding doors, sliding window treatments, farming implementations, and animatronics and robotics. However, these devices may be difficult to work with as they may use pre-set stroke lengths, requiring would-be users to carefully design their projects around a particular stroke length, or they may require that a user manually open and modify the linear actuator to adjust a stroke length of the device for a particular application.

### SUMMARY

Various implementations of systems, methods, and devices within the scope of the appended claims each have several aspects, no single one of which is solely responsible for the desirable attributes described herein. Without limiting the scope of the appended claims, some prominent features are described herein.

Details of one or more implementations of the subject matter described in this specification are set forth in the accompanying drawings and the description below. Other features, aspects, and advantages will become apparent from the description, the drawings, and the claims. Note that the relative dimensions of the following figures may not be drawn to scale.

One aspect of the present disclosure provides for an electric linear actuator with an adjustable stroke length. The linear actuator includes an electric motor, a lead screw fitted with a nut, a gear box to transfer force from the motor to rotate the lead screw, and a main rod configured to extend and to retract based on a rotation of the lead screw. The linear actuator further includes an extension limit switch configured to stop an extending rotation of the lead screw when the main rod is at a maximum extension, a retraction limit switch configured to stop a retracting rotation of the lead screw when the main rod is at a minimum extension, and an adjustment mechanism connected to at least one of the extension limit switch and the retraction limit switch to adjust a position of the at least one of the extension limit switch and the retract limit switch, changing at least one of the maximum extension and the minimum extension of the main rod.

Another aspect of the present disclosure provides for a linear actuator with an adjustable stroke length. The linear actuator includes a body, a main rod configured to extend and to retract from the body, and at least one limit switch configured to stop the main rod from extending or retracting past a position of the at least one limit switch thereby defining an end point of a stroke of the main rod. The linear actuator also includes an adjustment mechanism operably connected to the at least one limit switch, the adjustment mechanism configured to adjust a position of the at least one limit switch, thereby altering the end point of the stroke of the main rod.

### BRIEF DESCRIPTION OF THE DRAWINGS

FIG. 1 is an exemplary illustration of a linear actuator according to one aspect of the present disclosure.

FIG. 2 is an exemplary embodiment of a linear actuator with a moveable extension limit switch according to one aspect of the present disclosure.

FIG. 3 is an exemplary embodiment of a moveable limit switch component for a linear actuator according to one aspect of the present disclosure.

FIG. 4 is another exemplary embodiment of a moveable limit switch component for a linear actuator according to one aspect of the present disclosure.

### DETAILED DESCRIPTION

Various aspects of the novel item are described more fully hereinafter with reference to the accompanying drawings. The teachings disclosure can, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. Based on the teachings herein one skilled in the art should appreciate that the scope of the disclosure is intended to cover any aspect of the novel item disclosed herein, whether implemented independently of or combined with any other aspect of the invention. In addition, the scope of the invention is intended to cover such an item which is practiced using other structure, functionality, or structure and functionality in addition to or other than the various aspects of the invention set forth herein. Any aspect disclosed herein can be embodied by one or more elements of a claim.

Although aspects are described herein, many variations and permutations of these aspects fall within the scope of the disclosure. Although some benefits and advantages of the preferred aspects are mentioned, the scope of the disclosure is not intended to be limited to benefits, uses, or objectives. The detailed description and drawings are merely illustrative of the disclosure rather than limiting. In the following description, specific details are given to provide a thorough understanding of the examples. However, the examples may be practiced without these specific details.

Actuators are a type of device which can move and control a mechanism or a system. An actuator typically requires a control signal and a source of energy. Actuators come in at least two types: linear actuators and rotational actuators. Linear actuators create linear motion while rotary or rotational actuators create rotary or rotational motion. The description herein primarily relates to linear actuators, and more specifically to electric linear actuators. Comparable techniques may be used with other actuators, such as hydraulic and pneumatic linear actuators.

In general, a linear actuator converts input energy into linear motion—a pushing or a pulling movement, depending on directionality—based on a control signal. There are various types of linear actuators, including those which use hydraulic power, pneumatic power, and those which use motors based on either alternating or direct current. The selection of a type of power used in a linear actuator may depend on the demands of an application, such as the lifting force needed, the size of the actuator, and operational constraints such as the precision of motion required of the actuator. For example, a hydraulic system may be capable of immense forces, but those systems often require high pressure pumps, high pressure valves and piping, and a tank to hold all that hydraulic fluid. Conversely, an electric linear actuator may be used when a simple, safe, and clean movement is desired with accurate and smooth motion control.

Electric linear actuators may be configured for adjustments, tilting, pushing, pulling, and lifting with high forces. These linear actuators may be driven by AC or DC motors, such as 12- and 24-volt DC motors and AC motors such as 220-240 VAC 1-phase motors, 220-240/380-415 VAC 3-phase motors (50/60 Hz) or 24 VDC motors. Electric linear actuators may have a long lifetime with little or no maintenance needed, ensuring a low operating cost compared to other types of systems.

One type of electric linear actuator includes a motor, a gearbox to transfer energy from the motor to a lead screw, a driving nut on the lead screw, the driving nut configured to push and pull a main rod in and out. The motor size, gearing, and the lead screw can vary between different electric linear actuators, based on the needs of an application, such as the pushing/pulling force needed and a stroke length of the linear actuator for a given application.

Most linear actuators include limit switches which define a length of the stroke of the device. These limit switches are used to stop the motor from pushing the main rod past its maximum limit and to stop the motor from pulling the main rod past its minimum limit, thereby defining the stroke of the device and its stroke length. The distance between these limit switches effectively defines the stroke length of the linear actuator—the distance the main rod travels from its minimum extension to its maximum extension. For example, a linear actuator may have two limit switches: an extension limit switch that stops the device from extending its main rod past a maximum extension, and a retraction limit switch which stops the device from retracting its main rod past a minimum extension. Limit switches can operate on a variety of different technologies, including electro-mechanical limit switches, magnetic proximity limit switches, and rotary cam limit switches. These switches can cut power to the motor when the main rod is at either a maximum or a minimum stroke, potentially preventing the actuator from burning and stalling the motor when it reaches the end of its stroke. Limit switches may also prevent the actuator from jamming at the extreme ends of its stroke and other mechanical failures.

Limit switches may be implemented using diodes. For example, the limit switches may be part of a circuit which supplies power to the motor when a user or other external input instructs the linear actuator to extend or retract its main rod. These diodes may be activated when the main rod is near or touching the diode to stop a flow of electricity to the motor. This may effectively halt the motor and stop the movement of the main rod past its minimum or maximum stroke, depending on which limit switch is being activated. These limit switches can therefore prevent damage to the linear actuator that may be caused by over-extending the rod or by over-retracting the rod. Diodes may be particularly useful for this task since they allow electricity to flow in one direction but stop electricity from flowing in the opposite direction. This feature can be used to provide limit switches which allow the motor to function in the one direction, but not the other direction. For example, the limit switches may be placed in a circuit that provides power to the motor and may be configured to stop the flow of power in one direction when the main rod is near the limit switch. Thus, a limit switch may allow electricity to flow to the electric motor in one direction, such as to push the rod away from the limit switch, but may prevent electricity from flowing in the opposite direction, to push the rod past the limit switch. Accordingly, these limit switches may function to constrain the motion of the main rod of the linear actuator, while still allowing the device to function within its defined stroke length between the limit switches.

In one aspect, a linear actuator with an adjustable stroke length is described. The linear actuator includes a motor which is operably connected to a gear box. The gear box is configured to transfer force from the motor to rotate a lead screw. The lead screw is operably connected to a main rod, such as using a nut, such that rotation of the lead screw serves to extend or retract the main rod based on the direction of the rotation. The main rod is configured to move in a linear motion based on the rotation of the lead screw. The linear actuator further includes a retraction limit switch which is configured to stop a retracting rotation of the lead screw and to stop the retraction of the main rod when the main rod is in proximity to the retraction limit switch. The linear actuator further includes an extension limit switch which is configured to stop an extending rotation of the lead screw and to stop the extension of the main rod when the main rod is in proximity to the extension limit switch. At least one of the limit switches can further include an adjustment mechanism which allows the limit switch to be adjusted to change a stroke length of the linear actuator by changing at least one of the maximum extension and the minimum extension of the main rod, thereby adjusting one of the end points of the stroke of the main rod. For example, the adjustment mechanism can include one or more external screws which can affix the limit switch in place but, when loosened, can allow the limit switch to move a part of the length of the main rod to adjust the stroke length of the linear actuator. The adjustment mechanism may also include a ruler or other marking which provide an indication of the adjustment of the stroke length of the linear actuator. This may allow for more precision in adjustments to the stroke length of the linear actuator. For example, the linear actuator may include a one-inch ruler and allow the limit switch to be adjusted along the one inch of length to precisely set a stroke length of the linear actuator. Thus, the adjustment mechanism may allow for the stroke length of the main rod to be adjusted by one inch or more. Other adjustment lengths may also be used, as may be suited for a particular task and depending on the size of the linear actuator.

The limit switches may both be connected to a medium, but with one or more of the limit switches placed in a track that allows it to slide along a portion of the length of the main road. The limit switches may form part of a circuit, where the circuit is configured to cut off power to the motor and disconnect the circuit when the main rod or a portion thereof is in proximity to the limit switches. For example, the limit switches may be diodes which are capable of shutting off power of one polarity to the motor, thereby allowing the main rod to move away from the limit switch, but not to move past the limit switch, and thereby limiting its stroke length. The limit switches may be part of the same circuit, and the limit switches may be attached to ones another in the circuit using a flexible circuit, such as a flexible printed circuit board (“PCB”). This can allow the limit switches to move in relation to one another without disconnecting their circuit.

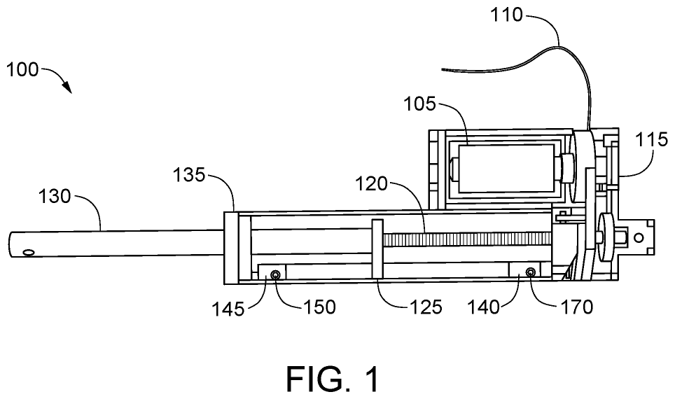

FIG. 1 is an exemplary illustration of a linear actuator 100 according to one aspect of the present disclosure. The linear actuator 100 includes a motor 105 powered by a power source 110. The motor 105 may be an AC or a DC-powered electric motor. The power source 110 may provide electricity to the motor 105, such as providing appropriate AC or DC electricity. In some aspects, a user may control a switch which controls the power to the power source 110, allowing a user to control whether power is applied to the power source 110 and potentially a polarity of the power provided to the power source 110. The motor 105 may be operably connected to the gearbox 115 which is configured to rotate the lead screw 120 when the motor 105 is turned on. The linear actuator 100 also includes a drive nut 125 which is attached to the lead screw 120, configured to move laterally along the length of the lead screw 120 as the lead screw 120 rotates due to the force of the motor 105 transmitted through the gearbox 115.

The drive nut 125 may be configured to move the main rod 130, which extends out of the body 135 of the linear actuator 100, due to the rotation of the lead screw 120. The main rod 130 may be configured to move linearly along a stroke length extended out of the body 135. The motion of the main rod 130 may be used as part of a larger objection to provide automation and movement. For example, a linear actuator 100 may be used to provide automation of motorized hatches, kitchen appliance lifts, throttle control systems, marine engine hatches, slide-out steps, snowplow adjusters, and a wide variety of other potential applications. The motor 105 may be configured to receive an external control signal, such as a signal to either extend or retract the main rod 130. For example, the motor 105 may be operably connected to a switch with three positions: to extend, hold stationary, and to retract the main rod 130. This may also be accomplished using two buttons (to retract and extend the main rod) or using a variety of other input mechanisms to control the motion of the main rod 130.

The range of motion of the main rod 135, its stroke length, may be defined by two limit switches: the retraction limit switch 140 and the extension limit switch 145. These limit switches 140, 145 may provide a signal to stop the motor 105 when the drive nut 125 is near, adjacent to, or touching the limit switches 140, 145. This signal may stop the motor 105 from operating in one of the two directions, thereby stopping the motion of the main rod 130 past its stroke length. Thus, each limit switch may define an end point of a stroke of the main rod, thereby determining the strong length of the main rod.

For example, the retraction limit switch 140 may be configured to cut off power to the motor 105 to prevent the linear actuator 100 from retracting the main rod 130 past its retraction limit. However, when the main rod 130 is fully retracted, it will still be able to move away from the retraction limit switch 140 to extend the main rod 130, but will not be able to move further towards the retraction limit switch 140 to further retract the main rod 130. Conversely, the extension limit switch 145 may be configured to cut off power to the motor 105 to prevent the linear actuator 100 from extending the main rod 130 past its extension limit. However, when the main rod 130 is fully extended, it will still be able to be moved away from the retraction limit switch 140 to extend the main rod 130, but will not be able to move further towards the retraction limit switch 140 to further retract the main rod 130.

Limit switches 140, 145 may operate by cutting off the power to the motor 105 in one direction when the drive nut 125 is near the limit switch 140, 145. This may be accomplished, for example, by driving the motor 105 using a circuit which passes through both limit switch 140, 145, where both limit switches 140, 145 are diodes. When activated by the proximity of the drive nut 125, these diodes may be able to cut off power to the motor 105 in one direction while allowing power to flow in the opposite. This can effectively stop the motor 105 from moving the drive nut 125 past the limit switch 140, 145 while allowing the motor 105 to move the drive nut 125 away from the limit switch 140, 145.

The position of the extension limit switch 145 and/or the retraction limit switch 140 may be adjusted by a user. For example, the extension limit switch 145 may be configured to be adjustable by a user without opening the body 135 of the linear actuator. The extension limit switch 145 may be placed on a track, which allows it to be adjusted within a range of positions along some or all the stroke length of the linear actuator 100. Adjusting the position of the extension limit switch 145 will have the effect of adjusting the stroke length of the linear actuator 100. For example, the extension limit switch 145 may be moved inward and outward, relative to the position of the retraction limit switch 140, to shorten and lengthen a stroke length of the linear actuator 100. This may allow a user of the linear actuator 100 to precisely configure the linear actuator 100 to have a specific stroke length. Similarly, retraction limit switch 140 may also be placed on a track and may also be adjusted by a user in a comparable manner. Linear actuators may include an adjustable extension limit switch only, an adjustable retraction limit switch only, or may include both adjustable extension limit switch and an adjustable retraction limit switch. Linear actuator 100, as illustrated in FIG. 1, includes both an adjustable retraction limit switch 140, removably secured by screw 170, and an adjustable extension limit switch 145, removably secured by screw 150.

For example, the extension limit switch 145 may be placed in a track running parallel to the main rod 130 and may be secured in a position by one or more screws 150 or other mechanisms. The one or more screws 150 extend from the extension limit switch 145 through the body 135 to allow them to be tightened and loosened by a user without having to open the body 135 of the linear actuator 100. When the one or more screws 150 are tightened, the extension limit switch 145 may be secured to the body 135 of the linear actuator 100 to prevent it from moving. When the one or more screws 150 are loosened, the extension limit switch 145 may be moved along a length of the track to shorten or lengthen the stroke length of the linear actuator 100, as may be useful for a given use of the linear actuator 100. Retraction limit switch 140 may be similarly placed in a track and secured to the body 135 of linear actuator 100 using screw 170.

In one aspect, the extension limit switch 145 may be secured to the body 135 of the linear actuator 100 using two screws or using another mechanism for removably securing extension limit switch 145 to the body 135. The extension limit switch 145 may be placed alongside an external ruler or other marking which may indicate the stroke length of the linear actuator 100 based on the position of the extension limit switch 145. For example, the extension limit switch 145 may be placed next to a one-inch ruler which may allow for precise, repeatable adjustments to the stroke length of the linear actuator. This may allow a user to adjust the stroke length of the linear actuator 100 to an exact length more easily. Similarly, the retraction limit switch 140 may also be secured to the body 135 in a comparable way to allow it to be adjusted as well, such as by using screw 170. This may allow a user to adjust both the extension limit of the linear actuator and the retraction limit of the linear actuator, allowing the linear actuator to be used for a wider range of projects. Generally, one or both limit switches may be placed in tracks and allowed to adjust the stroke of the main rod.

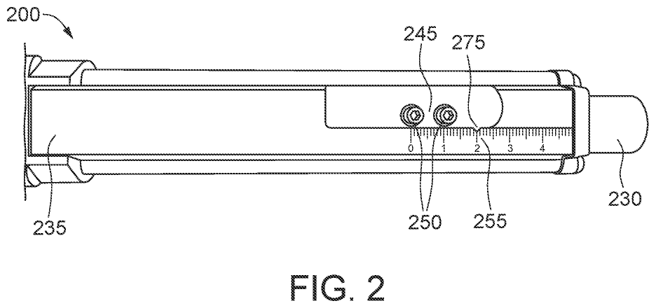

FIG. 2 is an exemplary embodiment of a linear actuator 200 with a moveable extension limit switch 245 according to one aspect of the present disclosure. As illustrated, the linear actuator 200 includes a body 235 and a main rod 230 which extends out of the body 235. The motion of the main rod 230 may be limited by limit switches, which are inside the body 235 of the linear actuator 200. In this illustration, the extension limit switch 245 is connected to an adjustment mechanism which includes two external screws 250. When these external screws 250 are tightened, the extension limit switch 245 may be fixed in place, limiting the maximum stroke length of the main rod 235. When these external screws 250 are loosened, the extension limit switch 245 may be moved along the path of the main rod 235 to shorten or lengthen its stroke length. A user may therefore control the stroke length of the main rod 235 by moving the extension limit switch 245 using the external screws 250. For example, a user may loosen both of external screws 250 by unscrewing them 360 degrees. This may allow a user to slide the adjustment mechanism to a desired position, thereby defining an end point for the stroke of the linear actuator 200. A user may then tighten the external screws 250 to keep the adjustment mechanism firmly in place and to set the stroke length of the linear actuator 200.

As illustrated, the body 230 of the linear actuator 200 may include a ruler 255 or another mechanism which allows a user to see the stroke length of the linear actuator 200. For example, the ruler 255 may include markings indicating a stroke length of the linear actuator 200 when the extension limit switch 245 is at a location along the ruler 255 or marking which indicate an adjustment to the stroke length from the maximum stroke length of the linear actuator. The linear actuator 200 may further include an indicator 275 which is configured to point to a particular location along the ruler 255. This may allow a user to select a desired stroke length and to match the stroke length selected between different linear actuators.

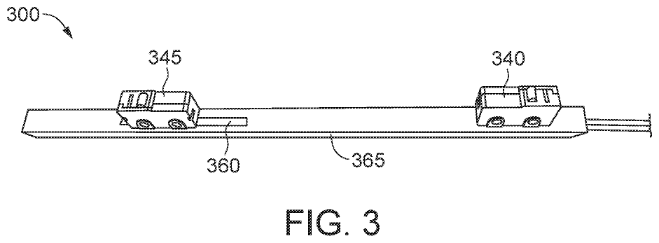

FIG. 3 is an exemplary embodiment of a moveable limit switch component 300 for a linear actuator according to one aspect of the present disclosure. As illustrated, two limit switches 340, 345 may be attached to a medium 365, such as a piece of plastic or other material. Here, the retraction limit switch 340 may be firmly affixed to the medium 365, such that it cannot move and remains stationary. However, the extension limit switch 345 is placed into a track 360 which allows it to move for a portion of a stroke length of an associated main rod of a linear actuator. Here, the extension limit switch 345 may be moved along the track which will alter the potential stroke length of a linear actuator when the moveable limit switch component 300 is included as part of a linear actuator. The track runs parallel to a stroke of the main rod, and the extension limit switch 345 defines an end point of the stroke of the linear actuator, thereby also defining the stroke length of the linear actuator. The extension limit switch 345 may be attached to an external means for removably securing it in position, such as the external screws 250 of FIG. 2. This may allow a user to adjust the position of the extension limit switch 345 without having to open the linear actuator and often without using any special tools or knowledge of the workings of a linear actuator. In other designs, either or both limit switches 340, 345 may be placed in a track to allow them to be moved without opening the linear actuator, as may be suitable for a particular application.

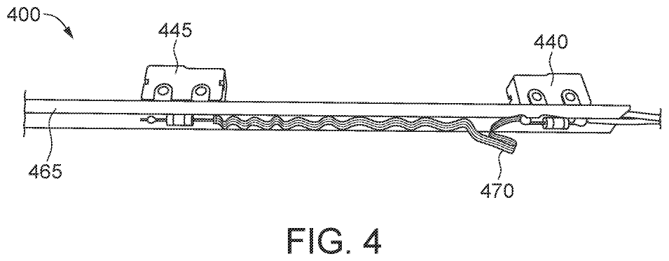

FIG. 4 is another exemplary embodiment of a moveable limit switch component 400 for a linear actuator according to one aspect of the present disclosure. Here, a retraction limit switch 440 and a movable extension limit switch 445 are attached to a medium 465. As with the moveable limit switch component 300 of FIG. 3, the extension limit switch 445 is in a track allowing it to be moved along a portion of the linear path of a main rod of a linear actuator. This movement allows the extension limit switch 445 to limit the motion and the stroke length of the linear actuator. The extension limit switch 445 may be electro-mechanical, magnetic proximity and rotary cam. In the moveable limit switch component 400, the retraction limit switch 440 and the extension limit switch 445 may be part of a circuit which can cut the power to a motor to stop the main rod from moving past either limit switch. This circuit may be possible by connected the retraction limit switch 440 and the extension limit switch 445 to one another using a flexible circuit such as a flexible PCB. This flexible circuit may allow one or both of the limit switches 440, 445 to be moved while still maintaining the circuit itself and allowing the limit switches 440, 445 to properly constrain the movement of the main rod and the stroke length of the linear actuator.

In one aspect of the present disclosure, an electric linear actuator with an adjustable stroke length is described. The electric linear actuator includes an electric motor, a lead screw fitted with a nut, and a gear box to transfer force from the motor to rotate the lead screw. The electric linear actuator further includes a main rod configured to extend and to retract based on a rotation of the lead screw, an extension limit switch configured to stop an extending rotation of the lead screw when the main rod is at a maximum extension, and a retraction limit switch configured to stop a retracting rotation of the lead screw when the main rod is at a minimum extension. The electric linear actuator also includes an adjustment mechanism connected to at least one of the extension limit switches and the retraction limit switch to adjust a position of the at least one of the extension limit switch and the retract limit switch, changing at least one of the maximum extension and the minimum extension of the main rod.

The adjustment mechanism may include one or more external screws which can be loosened to allow the limit switch to be moved along a stroke of the main rod to adjust the end point of the stroke. For example, these external screws can be thumb screws which can be loosened and tightened by hand to allow for a tools-free adjustment to the stroke length of the linear actuator. The adjustment mechanism can include a ruler, which may allow for more precise, repeatable adjustments of the stroke length of the linear actuator. Generally, one or more of the extension limit switch and the retraction limit switch may be placed in a track and the adjustment mechanism may allow movement of the at least one of the extension limit switch and the retraction limit switch along the track. For example, the track may be configured to run parallel to a path of the main rod, allowing for the adjustment of a limit switch parallel to the main rod.

The extension limit switch may be a diode configured to cut power to the motor when the main rod extends proximate to the diode, such as by placing the diode in a circuit which supplies power to the electric motor. The adjustment mechanism may be configured to allow the extension limit switch to be moved by up to one inch, thereby altering a stroke length of the main rod by up to one inch. Other adjustments lengths may also be used, based on the application, such as allowing for a wider range of adjustments to the stroke length by lengthening a track or other system for allowing movement for one or more limit switches. Generally, the adjustment mechanism may be external to a body of the linear actuator, thereby allowing adjustments to a stroke of the main rod without opening the body of the linear actuator. This can be used to offer an efficient, tool-free way to adjust the stroke length of the linear actuator.

In one aspect of the present disclosure, a linear actuator with an adjustable stroke length is disclosed. The linear actuator includes a body and a main rod configured to extend and to retract from the body. The linear actuator further includes at least one limit switch configured to stop the main rod from extending or retracting past a position of the at least one limit switch thereby defining an end point of a stroke of the main rod and an adjustment mechanism operably connected to the at least one limit switch, the adjustment mechanism configured to adjust a position of the at least one limit switch, thereby altering the end point of the stroke of the main rod.

Generally, the at least one limit switch may be an extension limit switch which defines a maximum extension of the main rod from the body. Alternatively, or additionally, the at least one limit switch may be a retraction limit switch which defines a minimum extension of the main rod from the body. Thus, the linear actuator may allow for adjustments to one or both of the extension limit switch and the retraction limit switch. The linear actuator may be an electric linear actuator and the at least one limit switch may be a diode. The limit switch(es) may be part of a circuit which supplies power to move the main rod and the limit switch(es) may be configured to cut off power to the circuit when the main rod or a portion thereof is in proximity to one of the limit switches.

The adjustment mechanism may include one or more external screws which can be loosened to allow the limit switch to be moved along a stroke of the main rod to adjust the end point of the stroke. For example, these external screws may be thumb screws which can be loosened and tightened without tools, allowing for tool-free adjustment of the stroke length of the linear actuator. The adjustment mechanism may include a ruler or other markings to provide information about alterations to the end point of the stroke of the main rod. The adjustment mechanism may allow the at least one limit switch to be moved one inch or more, thereby altering a stroke length of the main rod by one inch or more. In some aspects, the adjustment mechanism may allow for movements of up to one inch or may allow for a larger or smaller range of adjustments based on the needs of a particular application. Generally, the adjustment mechanism may be external to the body of the linear actuator, thereby allowing adjustments to the stroke of the main rod without opening the body of the linear actuator. The limit switch may be in a track which runs parallel to the stroke of the main rod, and the adjustment mechanism is configured to allow the at least one limit switch to be repositioned within the track.

Implementations disclosed herein provide a linear actuator with an adjustable stroke length. The phrase “based on” does not mean “based only on,” unless expressly specified otherwise. In other words, the phrase “based on” describes both “based only on” and “based at least on.” In the foregoing description, specific details are given to provide a thorough understanding of the examples. However, it will be understood by one of ordinary skill in the art that the examples may be practiced without these specific details. For example, the shape and size of various components may be changed for a given implementation or to match design preferences. Certain components may be combined with one another or may be excluded from some implementations. In other instances, such components, other structures, and techniques may be shown in detail to further explain the examples.

The previous description of the disclosed implementations is provided to enable any person skilled in the art to make or use the present invention. Various modifications to these implementations will be readily apparent to those skilled in the art, and the generic principles defined herein may be applied to other implementations without departing from the spirit or scope of the invention. Thus, the present invention is not intended to be limited to the implementations shown herein but is to be accorded the widest scope consistent with the principles and novel features disclosed herein.

What is claimed is:

1. An electric linear actuator with an adjustable stroke length, the linear actuator comprising:
an electric motor;
a lead screw fitted with a nut;
a gear box to transfer force from the motor to rotate the lead screw;
a main rod configured to extend and to retract based on a rotation of the lead screw;
an extension limit switch configured to stop an extending rotation of the lead screw when the main rod is at a maximum extension;
a retraction limit switch configured to stop a retracting rotation of the lead screw when the main rod is at a minimum extension; and
an adjustment mechanism connected to at least one of the extension limit switch and the retraction limit switch to adjust a position of the at least one of the extension limit switch and the retract limit switch, changing at least one of the maximum extension and the minimum extension of the main rod.

2. The linear actuator of claim 1, wherein the adjustment mechanism comprises one or more external screws which can be loosened to allow the limit switch to be moved along a stroke of the main rod to adjust the end point of the stroke.

3. The linear actuator of claim 1, wherein the adjustment mechanism includes a ruler.

4. The linear actuator of claim 1, wherein the at least one of the extension limit switch and the retraction limit switch are placed in a track and wherein the adjustment mechanism allows movement of the at least one of the extension limit switch and the retraction limit switch along the track.

5. The linear actuator of claim 4, wherein the track runs parallel to a direction of movement of the main rod.

6. The linear actuator of claim 1, wherein the extension limit switch comprises a diode configured to cut power to the motor when the main rod extends proximate to the diode.

7. The linear actuator of claim 1, wherein the adjustment mechanism allows the extension limit switch to be moved by up to one inch, thereby altering a stroke length of the main rod by up to one inch.

8. The linear actuator of claim 1, wherein the adjustment mechanism is external to a body of the linear actuator, thereby allowing adjustments to a stroke of the main rod without opening the body of the linear actuator.

9. A linear actuator with an adjustable stroke length, the linear actuator comprising:
a body;
a main rod configured to extend and to retract from the body;
at least one limit switch configured to stop the main rod from extending or retracting past a position of the at least one limit switch thereby defining an end point of a stroke of the main rod; and
an adjustment mechanism operably connected to the at least one limit switch, the adjustment mechanism configured to adjust a position of the at least one limit switch, thereby altering the end point of the stroke of the main rod.

10. The linear actuator of claim 9, wherein the at least one limit switch is an extension limit switch which defines a maximum extension of the main rod from the body.

11. The linear actuator of claim 9, wherein the at least one limit switch is a retraction limit switch which defines a minimum extension of the main rod from the body.

12. The linear actuator of claim 9, wherein the linear actuator is an electric linear actuator and the at least one limit switch comprises a diode.

13. The linear actuator of claim 9, wherein the at least one limit switch is part of a circuit which supplies power to move the main rod and wherein the at least one limit switch is configured to cut off power to the circuit when the main rod or a portion thereof is in proximity to the at least one limit switch.

14. The linear actuator of claim 9, wherein the adjustment mechanism comprises one or more external screws which can be loosened to allow the limit switch to be moved along a stroke of the main rod to adjust the end point of the stroke.

15. The linear actuator of claim 9, wherein the adjustment mechanism includes a ruler or other markings to provide information about alterations to the end point of the stroke of the main rod.

16. The linear actuator of claim 9, wherein the adjustment mechanism allows the at least one limit switch to be moved one inch or more, thereby altering a stroke length of the main rod by one inch or more.

17. The linear actuator of claim 9, wherein the adjustment mechanism is external to the body of the linear actuator, thereby allowing adjustments to the stroke of the main rod without opening the body of the linear actuator.

18. The linear actuator of claim 9, wherein the at least one limit switch is in a track which runs parallel to the stroke of the main rod, and the adjustment mechanism is configured to allow the at least one limit switch to be repositioned within the track.
